(19) United States
(12) Patent Application Publication
(10) Pub. No.: US 2007/0141877 A1
(43) Pub. Date: Jun. 21, 2007

(54) Self-cleaning socket pin

(75) Inventors: Se-Un Lee, Cheonan-si (KR); Seok-Young Yoon, Cheonan-si (KR); Jin-Woog Kim, Asan-si (KR); Hyeck-Jin Jeong, Cheonan-si (KR)

Correspondence Address: HARNESS, DICKEY & PIERCE, P.L.C., P.O. BOX 8910, RESTON, VA, 20195, US

(73) Assignee: Samsung Electronics Co. Ltd.

(21) Appl. No.: 11/638,584

(22) Filed: Dec. 14, 2006

(30) Foreign Application Priority Data
Dec. 19, 2005 (KR) 10-2005-0125456

(51) Int. Cl. H01R 13/44

(52) U.S. Cl. 439/137

(57) ABSTRACT

A socket pin for a test apparatus. The socket pin may have self-cleaning function and may include a main body of a socket, a bottom contact tip at a lower portion of the main body, a first spring in the main body and connected to the bottom contact tip, a top contact tip at an upper portion of the main body, and a conductive contact ball at end of the top contact tip.

### PRIORITY CLAIM

A claim of priority is made to Korean Patent Application No. 10-2005-0125456, filed on Dec. 19, 2005, in the Korean Intellectual Property Office, the disclosure of which is incorporated herein in its entirety by reference.

### BACKGROUND

1. Field

Example embodiments may relate to an electrical test apparatus for a semiconductor device, for example, to a socket pin adapted to be used in a test apparatus to electrically test a semiconductor device.

2. Description of the Related Art

Testing electrical characteristics of a semiconductor device may require an electrical connection between the semiconductor device and a tester. A socket board, a probe card, and/or a connector may be used as a test apparatus for electrically connecting a semiconductor device to a tester.

A socket board may be used when the semiconductor device is a semiconductor package. A probe card may be used when the semiconductor device is a semiconductor chip. A connector may be used for discrete devices.

A test apparatus, for example, a socket board may function to interconnect an external connection terminal of a semiconductor package and a tester to mutually exchange electrical signals therebetween. A socket board may include a POGO pin interconnecting the external connection terminals of the semiconductor device and the tester. The POGO pin may include a spring disposed inside thereof. The spring may enable the semiconductor device to be effectively connected to the tester. The spring may also absorb mechanical stress, which may be generated when the semiconductor device is connected to the tester.

FIG. 1 is a conventional test apparatus including a socket pin.

Referring to FIG. 1, in order to perform an electrical test on a semiconductor device 10 using a conventional socket pin 30, a spring 34 of a POGO pin should contract (right half of FIG. 1) and return to normal (left half of FIG. 1). Reference numerals 12 and 22 respectively may relate to an external connection terminal of a semiconductor device 10 and a pusher for pressing the external connection terminal 12. The reference numeral 36 may relate to a bottom contact tip, which may be connected to a printed circuit board 40. The socket pin 30 may generate a stroke S1 as the spring 34 contracts and returns by the pusher 22. As a result, the external connection terminal 12 of the semiconductor device 10 and the printed circuit board 40 may be interconnected by the socket pin 30.

However, because a portion of a top contact tip 32, which may contact the external connection terminal 12, may be formed in a crown-shape, the conventional socket pin 30 may have disadvantages. The top contact tip 32 having a crown-shaped portion may contact the external connection terminal 12 of the semiconductor device 10, and may only reciprocate in a vertical direction. Accordingly, foreign materials, for example, flakes of solder plated on a surface of the external connection terminal 12 may accumulate on the crown-shaped portion. The flakes may cause a short circuit with an adjacent POGO pin during the electrical test. Therefore, the flakes may have to be cleaned off. However, during the cleaning process, the POGO pin may be mechanically damaged. The mechanical damage may cause a reduction in the service life of the POGO pin.

The crown-shaped portion of the top contact tip 32 may be easily worn. If the top contact tip 32 is formed of a material having a relatively high wear-resistance, or an elastic force of the spring 34 is too high, the surface of the external connection terminal 12 of the semiconductor device 10 may be damaged.

### SUMMARY

Example embodiments may provide a self-cleaning socket pin, which may reduce or prevent foreign materials from accumulating on an upper contact tip, improve the wear-resistance, and/or suppress surface damage on external connection terminal of a semiconductor device.

Example embodiments may also provide a test apparatus including a self-cleaning socket pin.

In an example embodiment, a self-cleaning socket pin may include a main body, a bottom contact tip at a first end of the main body, a first spring in the main body and configured to connect with the bottom contact tip, a top contact tip at a second end of the main body, and a conductive contact ball on the top contact tip and adapted to rotate thereon.

In another example embodiment, a self-cleaning socket pin may include a main body, a bottom contact tip at a first end of the main body, a first elastic device in the main body and configured to connect with the bottom contact tip, a top contact tip at a second end of the main body, a second elastic device in the top contact tip, and a conductive contact on the top contact tip and adapted to rotate thereon.

### BRIEF DESCRIPTION OF THE DRAWINGS

The above and other features of the example embodiments may become more apparent with the detail description thereof with reference to the attached drawings in which:

FIG. 1 illustrates a conventional test apparatus having a socket pin;

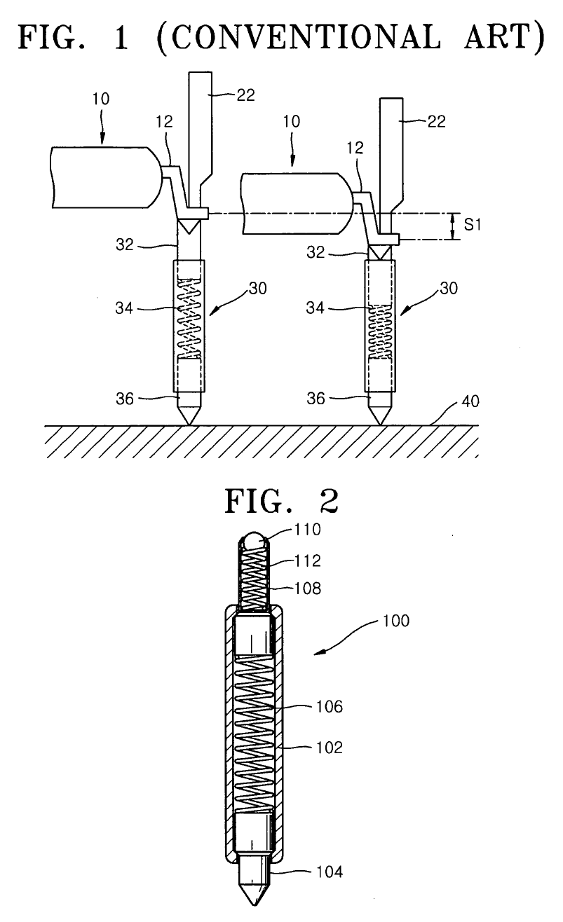

FIG. 2 is a sectional view illustrating a socket pin according to an example embodiment;

FIGS. 3 and 4 are sectional views illustrating a method of performing an electrical test on a semiconductor device using the socket pin illustrated in FIG. 2.

FIGS. 5 and 6 are sectional and top views illustrating when only a second spring contracts and both a first spring and the second spring contract, respectively; and

FIG. 7 is an exploded sectional view of a test apparatus having the socket pin illustrated in FIG. 2.

### DETAILED DESCRIPTION OF EXAMPLE EMBODIMENTS

Example embodiments will now be described more fully with reference to the accompanying drawings. Example embodiments may, however, be embodied in many different forms and should not be construed as being limited to the example embodiments set forth herein; rather, these example embodiments are provided so that this disclosure will be thorough and complete, and will fully convey the concept of the invention to those skilled in the art.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items. It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Example embodiments may be described herein with reference to cross-section illustrations that may be schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to limit the example embodiments. Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

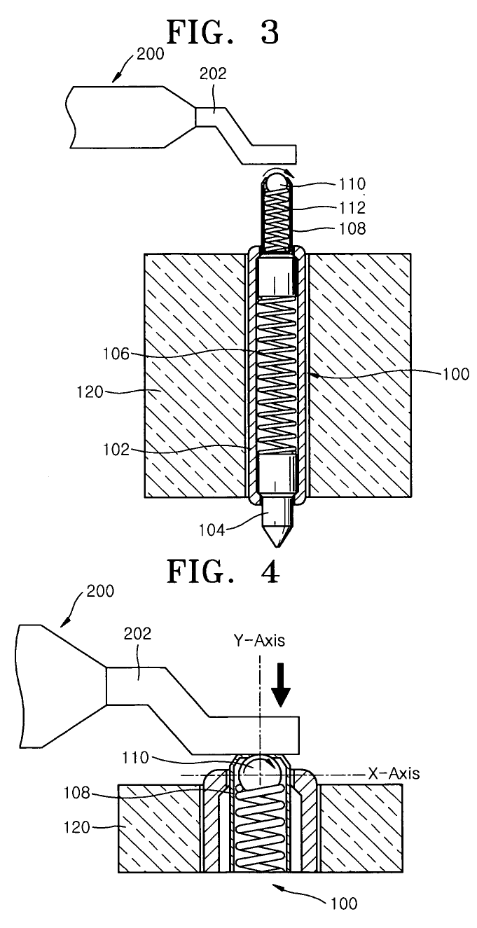

FIG. 2 is a sectional view illustrating a socket pin of a test apparatus according to an example embodiment.

Referring to FIG. 2, a socket pin 100 may include a main body 102, for example, a POGO pin body. The main body 102 may include an upper portion and a lower portion.

The socket pin 100 may include a bottom contact tip 104 disposed on the bottom portion of the main body 102. The bottom contact tip 104 may be configured to connect to a printed circuit board (not shown) of a test apparatus (not shown).

The socket pin 100 may also include a first spring 106 disposed in the main body 102 above the bottom contact tip 104.

The socket pin 100 may further include a top contact tip 108 disposed on the upper portion of the main body 102. The top contact tip 108 may be configured to connect to an external connection terminal (not shown) of a semiconductor device (not shown). The top contact tip 108 may have a contact ball 110 formed of a conductive material. The contact ball 110 may be rotatably disposed at one end of the top contact tip 108. The contact ball 110 may be rotatably fixed on a second spring 112 disposed in the top contact tip 108. The main body 102, the bottom contact tip 104, and/or the top contact tip 108 may be coated with Au to enhance signal transmission performance.

The second spring 112 disposed inside the top contact tip 108 may be in contact, but not permanently connected with the contact ball 110. The second spring 112 may apply an elastic force to the contact ball 110 to assist the contact ball 110 to connect to the external connection terminal of the semiconductor device. In other words, the contact ball 110 may be disposed on the top contact tip 108 to rotate thereabout. When the external connection terminal contacts the top contact tip 108, any foreign materials that may adhere to the top contact tip 108 may be removed due to a rotation of the contact ball 110, thereby performing a self-cleaning function. Furthermore, because the contact area between the top contact tip 108 and the external connection terminal of the semiconductor device is reduced, wear-resistance may be improved.

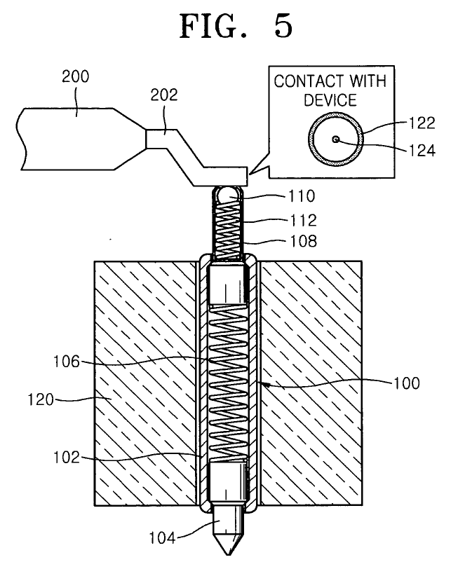

FIGS. 3 and 4 are sectional views illustrating a method of performing an electrical test on a semiconductor device using the socket pin illustrated in FIG. 2.

Referring to FIGS. 3 and 4, a semiconductor device 200 may include a lead 202, for example, an external connection terminal. The lead 202 may transmit or receive an electric signal to or from a socket pin 100 to perform the electrical test of the semiconductor device 200. The socket pin 100 may be fixed to a socket insulation unit 120. When a contact ball 110 disposed at one end of the socket pin 100 contacts the lead 202, the contact ball 110 may rotate in a direction indicated by the arrow in FIGS. 3-4.

According to example embodiments, because a top contact tip 108 may be provided at an end with the contact ball 110, wear and tear on the end of the contact tip 108 may be reduced. Additionally, even if foreign materials, for example, dust and solder flakes of the lead 202 adhered to the contact ball 110, the foreign materials may be removed from the contact ball 110 by the rotation of the contact ball 110.

It should be noted that example embodiments may be applied to a semiconductor package having a solder ball, which may function as an external connection terminal. Example embodiments may also be applied to a semiconductor chip. For example, the self-cleaning socket pin 100 may be used as a socket pin of a probe card for an electrical die sorting (EDS) process.

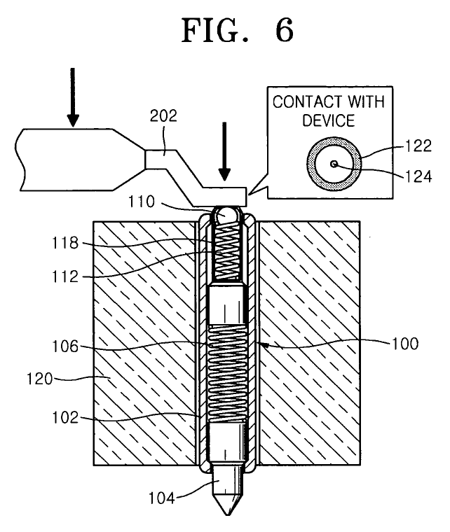

FIGS. 5 and 6 are sectional and top views illustrating when only a second spring contracts and both a first spring and the second spring contract, respectively.

FIG. 5 illustrates a state where a socket pin 100 contacts a lead 202, but only a second spring 112 disposed in a top contact tip 108 contracts. FIG. 6 illustrates a state where the socket pin 100 contacts the lead 202, and both the second spring 112 and a first spring 106 disposed in a main body 102 contract. Because the socket pin 100 and a semiconductor device 200 may contact each other by the operation of the first and second springs 106 and 112, the force applied to the lead 202 may be reduced, thereby reducing damage to the surface of the lead 202.

The lead 202 of the semiconductor device 200 and a printed circuit board (not shown) may be interconnected by the operation of the first and second springs 106 and 112. Therefore, the elastic coefficient k of the second spring 112 may be lower than that of the first spring 106.

According to example embodiments, the contact ball 110 of the socket pin 100 may contact the lead 202 through a dual-contact structure. In other words, as illustrated in FIG. 5, a top contact tip 122 may contact the lead 202 by a recoil action of the second spring 112. At this point, the contact area 122 between the lead 202 and the top contact tip 122 may be relatively small. However, when the lead 202 is pressed as indicated by the arrow in FIG. 6, a secondary contact between the lead 202 and the top contact tip 122 may be realized to increase the contact area.

The reference numeral 124 may indicate a contact area between the contact ball 110 and lead 202.

The contact ball 110 may be formed of or coated with a material selected from a conductive polymer, Cu, Ni, and beryllium or an alloy including at least one of the conductive polymer, Cu, Ni, and beryllium.

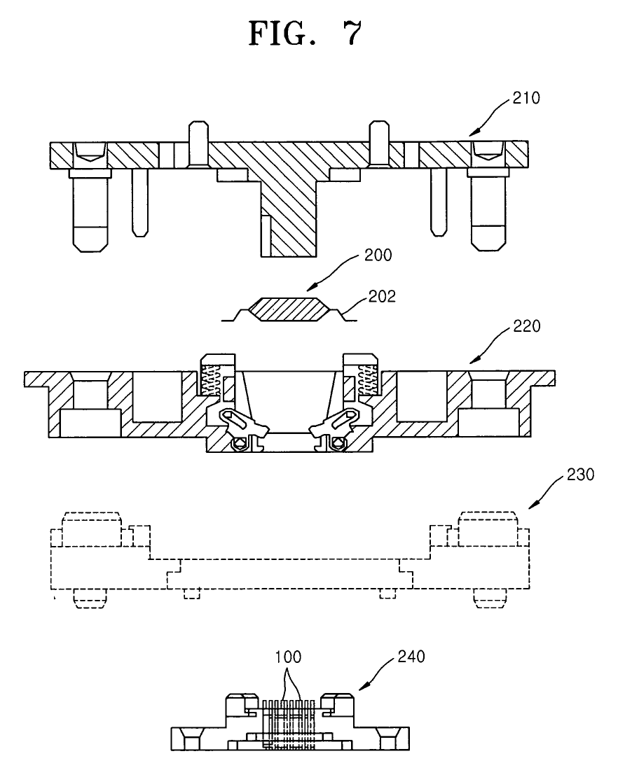

FIG. 7 is an exploded sectional view of a test apparatus having the socket pin illustrated in FIG. 2.

Referring to FIG. 7, a test apparatus may include an inserter 220 in which a semiconductor device 200 may be inserted therein, a pusher 210 disposed above the inserter 220 to press the semiconductor device 200, a socket guide 230 disposed below the inserter 220, and/or a socket unit 240 disposed on an assembly of the inserter 220, the pusher 210 and the socket guide 230 connecting the semiconductor device 200 to the tester apparatus.

A socket pin 100 may be placed in the socket unit 240. As described above, the socket pin 100 may have a contact ball rotatably disposed on a top contact tip and first and/or second springs disposed in the socket pin. The socket pin may include a main body, a bottom contact tip and/or a top contact tip. The first spring may be disposed in the main body and the second spring may be disposed in the top contact tip.

Although example embodiments and the figures described the first and second spring as a coil spring, it is understood by a person of ordinary skill that the first and/or second spring may be a piston, an elastic member, a diaphragm, and the like.

According to example embodiments, as a contact ball may be disposed on an end of a top contact tip and first and second springs, the top contact tip may not be easily contaminated and/or worn, and damage to the external connection terminal of the semiconductor device may be reduced.

In example embodiments, the first spring 106 and the second spring 112, may be a single spring. In example embodiments, the top contact tip 108 and/or the contact ball 110 may have any shape which reduces or prevents the accumulation of flakes and/or other debris.

While example embodiments have been shown and described thereof, it will be understood by those of ordinary skill in the art that various changes in form and details may be made therein without departing from the scope of example embodiments as defined by the following claims.

What is claimed is:

1. A self-cleaning socket pin comprising:
a main body;
a bottom contact tip at a first end of the main body;
a first spring in the main body and configured to connect with the bottom contact tip;
a top contact tip at a second end of the main body; and
a conductive contact ball on the top contact tip and adapted to rotate thereon.

2. The socket pin of claim 1, further including a second spring in the top contact pin, wherein the conductive ball is on the second spring.

3. The socket pin of claim 2, wherein an elastic coefficient of the second spring is less than that of the first spring.

4. The socket pin of claim 1, wherein the bottom contact tip is adapted to connect to a printed circuit board, and the top contact tip is adapted to connect to an external circuit board.

5. The socket pin of claim 4, wherein the printed circuit board is a probe card used for testing a semiconductor chip or a socket used for testing a semiconductor package.

6. The socket pin of claim 1, wherein the conductive contact ball is formed of a material selected from the group consisting of conductive polymer, Cu, Ni, beryllium, and an alloy including at least one of the conductive polymer, CU, Ni, and beryllium.

7. The socket pin of claim 1, wherein the conductive contact ball is coated with a material selected from the group consisting of conductive polymer, Cu, Ni, and beryllium.

8. The socket pin of claim 1, wherein the socket pin is adapted to be used in a socket unit.

9. The socket pin of claim 8, wherein the socket unit is adapted to be used in a test apparatus, the test apparatus adapted to test electrical characteristics of a semiconductor device.

10. The socket pin of claim 9, wherein the test apparatus includes:
an inserter adapted to fix the semiconductor device therein;
a pusher above the inserter to press the semiconductor device into the inserter;
a socket guide below the inserter; and
the socket unit on an assembly of the inserter, the pusher, and the socket guide.

11. A self-cleaning socket pin comprising:
a main body;
a bottom contact tip at a first end of the main body;
a first elastic device in the main body and configured to connect with the bottom contact tip;
a top contact tip at a second end of the main body;
a second elastic device in the top contact tip; and
a conductive contact on the top contact tip and adapted to rotate thereon.

12. The socket pin of claim 11, wherein an elastic coefficient of the second elastic device is less than that of the first elastic device.

13. The socket pin of claim 11, wherein the bottom contact tip is adapted to connect to a printed circuit board, and the top contact tip is adapted to connect to an external circuit board.

14. The socket pin of claim 13, wherein the printed circuit board is a probe card used for testing a semiconductor chip or a socket used for testing a semiconductor package.

15. The socket pin of claim 11, wherein the conductive contact ball is formed of a material selected from the group consisting of conductive polymer, Cu, Ni, beryllium, and an alloy including at least one of the conductive polymer, CU, Ni, and beryllium.

16. The socket pin of claim 11, wherein the conductive contact ball is coated with a material selected from the group consisting of conductive polymer, Cu, Ni, and beryllium.

17. The socket pin of claim 11, wherein the first and second elastic device are configured to contract independent from each other.

18. The socket pin of claim 11, wherein the socket pin is adapted to be used in a socket unit.

19. The socket pin of claim 18, wherein the socket unit is adapted to be used in a test apparatus, the test apparatus adapted to test electrical characteristics of a semiconductor device.

20. The socket pin of claim 19, wherein the test apparatus includes:
an inserter adapted to fix the semiconductor device therein;
a pusher above the inserter to press the semiconductor device into the inserter;
a socket guide below the inserter; and
the socket unit on an assembly of the inserter, the pusher, and the socket guide.
